(19) United States
(12) Patent Application Publication
(10) Pub. No.: US 2020/0166448 A1
(43) Pub. Date: May 28, 2020

(54) GAS FLOW SENSOR AND PARTICLE COUNTER

(71) Applicant: NGK INSULATORS, LTD., Nagoya-City (JP)

(72) Inventors: Hidemasa OKUMURA, Nagoya-City (JP); Kazuyuki Mizuno, Nagoya-City (JP); Keiichi Kanno, Nagoya-City (JP)

(73) Assignee: NGK INSULATORS, LTD., Nagyoya-City (JP)

(21) Appl. No.: 16/776,913

(22) Filed: Jan. 30, 2020

Related U.S. Application Data
(63) Continuation of application No. PCT/JP2018/024436, filed on Jun. 27, 2018.

(30) Foreign Application Priority Data
Aug. 10, 2017 (JP) 2017-155299

(51) Int. Cl. G01N 15/06; G01F 1/64

(52) U.S. Cl. CPC G01N 15/0656; G01F 1/64

(57) ABSTRACT

A gas flow sensor includes a housing including a gas flow path, a charge generator causing aerial discharge and generating charges within the gas flow path, a charge capturing electrode capturing the charges generated within the gas flow path, and a first control unit determining information about a gas flow on the basis of a physical quantity that varies depending on a quantity of the charges captured by the charge capturing electrode.

### BACKGROUND OF THE INVENTION

### 1. Field of the Invention

The present invention relates to a gas flow sensor and a particle counter.

### 2. Description of the Related Art

Various gas flow sensors, such as a gas flow-rate sensor, for example, are known. Gas flow-rate sensors utilizing various principles are known, and one type among them is a differential pressure sensor. In the differential pressure sensor, a differential pressure across an orifice is measured, and a flow rate is determined on the basis of the measured differential pressure. For example, Patent Literature (PTL) 1 discloses that type of differential pressure sensor in which a gas flow rate is measured with high responsivity and high accuracy from an operation range where the gas flow rate in an engine is small to an operation range where the gas flow rate is large by increasing and decreasing a passage area of the orifice. There are many other types of gas flow-rate sensors in addition to the differential pressure sensor.

### CITATION LIST

### Patent Literature

PTL 1: JP 2014-98606 A

### SUMMARY OF THE INVENTION

If a sensor utilizing a measurement principle unknown up to now is developed as the gas flow sensor, such a sensor is expected to be utilized in various fields by virtue of its advantage.

The present invention has been made to solve the above-described problem, and a main object of the present invention is to provide a gas flow sensor utilizing the measurement principle unknown up to now.

The present invention provides a gas flow sensor including:
a housing including a gas flow path;
a charge generator causing aerial discharge and generating charges within the gas flow path;
a charge capturing electrode capturing the charges generated within the gas flow path; and
a first control unit determining information about a gas flow on the basis of a physical quantity that varies depending on a quantity of the charges captured by the charge capturing electrode.

In the gas flow sensor described above, the charges generated with the aerial discharge caused by the charge generator are captured by the charge capturing electrode, and the information about the gas flow is determined on the basis of the physical quantity that varies depending on the quantity of the captured charges. Such a method is based on a measurement principle unknown up to now. Thus, because of using the measurement principle unknown up to now, the gas flow sensor according to the present invention is expected to be utilized in various fields by virtue of its advantage.

In this Description, the “charges” include not only positive electric charges and negative electric charges, but also ions. The “physical quantity” needs only to be information varying depending on a quantity of the charges, and it is, for example, a current.

In the gas flow sensor according to the present invention, the information may be at least one among a flow rate of gas flowing through the gas flow path, a flow speed of the gas, a frequency of pulsation of the gas when generated, the presence of the pulsation of the gas, and the occurrence of clogging in the gas flow path. Looking at, for example, a current (quantity of the charges per unit time) flowing in the charge capturing electrode, the current is correlated with a flow rate of the gas passing through the gas flow path. Therefore, the flow rate of the gas can be determined on the basis of the current. Furthermore, if an opening area is known, a flow speed of the gas can be determined from the flow rate. When the flow rate of the gas is intermittently changed, this can be regarded as indicating the occurrence of the gas pulsation, and a frequency of the gas pulsation when generated can be determined from a period of the intermittent change in the flow rate of the gas. Moreover, when the state in which the flow rate of the gas is zero continues for a predetermined time or longer, this can be regarded as indicating the occurrence of clogging in the gas flow path.

In the gas flow sensor according the present invention, the charge capturing electrode may capture the charges under an electric field. With this feature, the charges can be efficiently captured by the charge capturing electrode.

In the gas flow sensor according the present invention, the charge generator may include a discharge electrode and a ground electrode, the discharge electrode may be disposed along an inner surface of the gas flow path, and the ground electrode may be embedded in the housing or disposed along the inner surface of the gas flow path. With those features, since the gas flow passing through the gas flow path is less susceptible to obstruction by the charge generator, the information about the gas flow rate can be more accurately determined. The discharge electrode and the ground electrode may be bonded to the inner surface of the gas flow path by using an inorganic material, or may be joined to the inner surface of the gas flow path by sintering.

In the gas flow sensor according the present invention, the charge capturing electrode may be disposed at each of positions between the charge generator and one opening of the gas flow path and between the charge generator and the other opening of the gas flow path. With that feature, the information about the gas flow can be determined in not only the case in which the gas flows from the one opening to the other opening of the gas flow path, but also the case in which the gas flows in a direction reversed to that in the above case. It is also possible to more accurately detect the occurrence of the gas pulsation and the frequency of the gas pulsation.

The present invention further provides a particle counter counting the number of particles contained in gas, the particle counter including:
one of the gas flow sensors described above;
a charged particle capturing electrode capturing charged particles that are produced with addition of the charges to the particles contained in the gas flowing into the gas flow path; and
a second control unit determining the number of the particles on the basis of a physical quantity that varies depending on a quantity of the charges captured by the charged particle capturing electrode,
wherein the charge generator, the charge capturing electrode, and the charged particle capturing electrode are disposed side by side in the mentioned order,
the first control unit determines at least a flow rate of the gas as information about a flow of the gas, and
the second control unit determines the number of the particles in the gas per unit volume on the basis of both the physical quantity that varies depending on the quantity of the charges captured by the charged particle capturing electrode and the flow rate of the gas determined by the first control unit.

According to the particle counter described above, the charged particles produced with addition of the charges, having been generated in the gas flow path, to the particles contained in the gas flowing into the gas flow path are captured by the charged particle capturing electrode, and the number of the particles in the gas per unit volume is determined on the basis of both the physical quantity that varies depending on the quantity of the captured charges and the flow rate of the gas. Thus, the number of the particles can be determined in consideration of the flow rate of the gas. In addition, since the flow rate of the gas and the number of the particles are both determined by utilizing the charges generated with the aerial discharge caused by the charge generator, a device structure is made compact.

Alternatively, the present invention provides a particle counter counting the number of particles contained in gas, the particle counter including:
one of the gas flow sensors described above; and
a second control unit determining the number of the particles on the basis of a physical quantity that varies depending on a quantity of the charges captured by the charge capturing electrode,
wherein the first control unit determines at least a flow rate of the gas,
the charge capturing electrode does not capture charged particles that are produced with addition of the charges to the particles contained in the gas flowing into the gas flow path, and captures extra charges having not been added to the particles, and
the second control unit determines the number of the particles in the gas per unit volume on the basis of both the physical quantity that varies depending on the quantity of the charges captured by the charge capturing electrode and the flow rate of the gas determined by the first control unit.

According to the particle counter described above, ones (extra charges) among the charges generated in the gas flow path, those ones having not been added to the particles contained in the gas, are captured by the charge capturing electrode, and the number of the particles in the gas per unit volume is determined on the basis of both the physical quantity that varies depending on the quantity of the captured charges and the flow rate of the gas. Thus, the number of the particles can be determined in consideration of the flow rate of the gas. In addition, since the flow rate of the gas and the number of the particles are both determined by utilizing the charges generated with the aerial discharge caused by the charge generator, a device structure is made compact.

In the particle counter according to the present invention, the first control unit may detect the presence of pulsation of the gas, and the second control unit may stop an operation of determining the number of the particles when the pulsation of the gas is detected by the first control unit. When the pulsation of the gas has occurred, the operation of determining the number of the particles is stopped because it is difficult to accurately determine the number of the particles.

In the particle counter according to the present invention, the first control unit may detect the occurrence of clogging in the gas flow path, and the second control unit may stop an operation of determining the number of the particles when the clogging in the gas flow path is detected by the first control unit. When the clogging in the gas flow path has occurred, the operation of determining the number of the particles is stopped because it is difficult to accurately determine the number of the particles.

### BRIEF DESCRIPTION OF THE DRAWINGS

FIG. 1 is a sectional view illustrating a schematic structure of a gas flow sensor 10.

FIG. 2 is a perspective view of a charge generator 20.

FIG. 3 is a graph depicting a relation between a current flowing in a charge capturing electrode 30 and a gas flow rate.

FIG. 4 is a sectional view illustrating a schematic structure of the gas flow sensor 10 to which a charge capturing electrode 130 is added.

FIG. 5 is a sectional view illustrating a schematic structure of the gas flow sensor 10 to which the charge capturing electrode 130 is added.

FIG. 6 is a sectional view illustrating a schematic structure of the gas flow sensor 10 in which a pair of electric-field generation electrodes 34 and 36 are used.

FIG. 7 is a sectional view illustrating a schematic structure of a particle counter 50.

FIG. 8 is a sectional view illustrating a schematic structure of the particle counter 50 to which a charged particle capturing electrode 260 and a charge capturing electrode 230 are added.

FIG. 9 is a sectional view illustrating the schematic structure of the particle counter 50 to which the charged particle capturing electrode 260 and the charge capturing electrode 230 are added.

FIG. 10 is a partial sectional view illustrating another structure to generate electric fields above the capturing electrodes 30 and 60.

FIG. 11 is a sectional view illustrating a schematic structure when the gas flow sensor 10 is used as a particle counter.

### DETAILED DESCRIPTION OF THE INVENTION

### First Embodiment

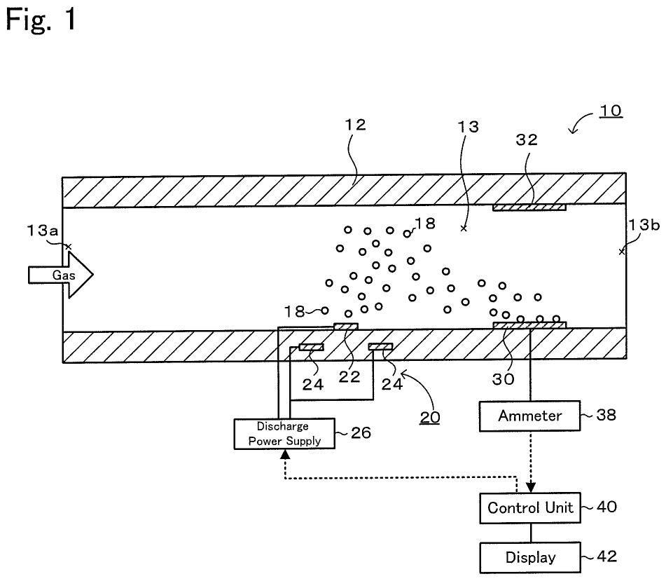

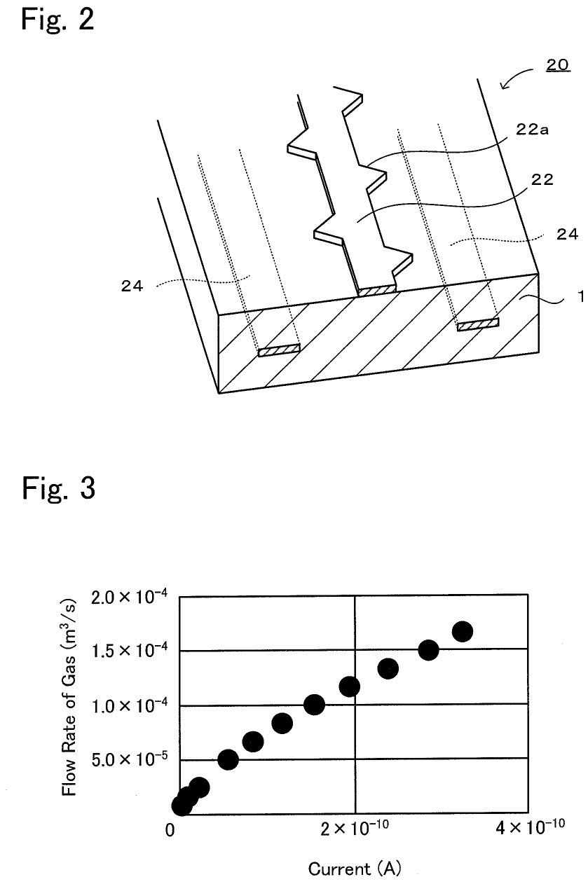

FIG. 1 is a sectional view illustrating a schematic structure of a gas flow sensor 10, FIG. 2 is a perspective view of a charge generator 20, and FIG. 3 is a graph depicting a relation between a current flowing in a charge capturing electrode 30 and a gas flow rate.

The gas flow sensor 10 is to detect information about a gas flow. The gas flow sensor 10 includes a housing 12, a charge generator 20, a charge capturing electrode 30, and a control unit 40.

The housing 12 is made of an insulating material and includes a gas flow path 13. The gas flow path 13 penetrates through the housing 12 from one opening 13a to the other opening 13b. The insulating material is, for example, a ceramic material. Types of the ceramic material are not limited to particular ones and include, for example, alumina, aluminum nitride, silicon carbide, mullite, zirconia, titania, silicon nitride, magnesia, glass, and mixtures of the formers. Within the gas flow path 13, the charge generator 20 and the charge capturing electrode 30 are disposed side by side in the mentioned order from the upstream side toward the downstream side of the gas flow (here, along a direction from the opening 13a toward the opening 13b).

The charge generator 20 is disposed to generate charges within the gas flow path 13. The charge generator 20 includes a discharge electrode 22 and two ground electrodes 24 and 24. The discharge electrode 22 is disposed along an inner surface of the gas flow path 13 and, as illustrated in FIG. 2, includes a plurality of fine projections 22a formed along its rectangular periphery. The two ground electrodes 24 and 24 are each a rectangular electrode and are embedded in a wall (housing 12) of the gas flow path 13 parallel to the discharge electrode 22 with a spacing held therebetween. In the charge generator 20, a high-frequency high voltage (e.g., a pulse voltage) of a discharge power supply 26 is applied between the discharge electrode 22 and each of the two ground electrodes 24 and 24, whereby aerial discharge is generated with a potential difference between both the electrodes. On that occasion, a portion of the housing 12 between the discharge electrode 22 and each of the ground electrodes 24 and 24 serves as a dielectric layer. The aerial discharge ionizes gas present around the discharge electrode 22 and generates positive or negative charges 18. From the viewpoint of heat resistance during discharge, a metal with a melting point of 1500° C. or higher is preferably used as a material of the discharge electrode 22. Examples of such a metal include titanium, chromium, iron, cobalt, nickel, niobium, molybdenum, tantalum, tungsten, iridium, platinum, gold, and alloys of the formers. Above all, platinum and gold having small ionization tendency is preferable from the viewpoint of corrosion resistance. The discharge electrode 22 may be bonded to the inner surface of the gas flow path 13 with a glass paste interposed therebetween, or may be formed as a sintered metal by firing a metal paste that is coated on the inner surface of the gas flow path 13 by screen printing. The ground electrodes 24 and 24 can also be made of the similar material to that of the discharge electrode 22.

The charge capturing electrode 30 is an electrode for capturing the charges 18 generated by the charge generator 20 and is disposed along the inner surface of the gas flow path 13. An electric-field generation electrode 32 is disposed in the gas flow path 13 at a position opposing to the charge capturing electrode 30. The electric-field generation electrode 32 cooperating to capture the charges is also disposed along the inner surface of the gas flow path 13. When a voltage of an electric-field generation power supply, not illustrated, is applied between the electric-field generation electrode 32 and the charge capturing electrode 30, an electric field is generated between the electric-field generation electrode 32 and the charge capturing electrode 30 (above the charge capturing electrode 30). The charges 18 generated with the aerial discharge caused by the charge generator 20 are attracted to and captured by the charge capturing electrode 30 under the electric field.

The control unit 40 is constituted by a well-known microcomputer including CPU, ROM, RAM, etc. The control unit 40 adjusts the voltage of the discharge power supply 26 and receives a current from an ammeter 38 that measures the current flowing in the charge capturing electrode 30. The control unit 40 determines a flow rate of gas passing through the gas flow path 13 on the basis of the current input from the ammeter 38, and displays the determined gas flow rate on a display 42. The control unit 40 corresponds to a first control unit in the present invention.

An example of manufacturing the gas flow sensor 10 will be described below. Of the gas flow sensor 10, the housing 12 including the various electrodes 22, 24, 30 and 32 can be fabricated by using a plurality of ceramic green sheets. More specifically, after forming cutouts, through-heles, and/or grooves and screen-printing the electrodes and wiring patterns in and on the individual ceramic green sheets as required, those ceramic green sheets are laminated and fired. The cutouts, the through-heles, and the grooves may be previously filled with a material (e.g., an organic material) that disappears when fired. The housing 12 including the various electrodes 22, 24, 30 and 32 is thus obtained. Then, the discharge power supply 26 is connected to the discharge electrode 22 and the ground electrodes 24 and 24, and the ammeter 38 is connected to the charge capturing electrode 30. Furthermore, the control unit 40 is connected to the discharge power supply 26, the ammeter 38, and the display 42. In such a manner, the gas flow sensor 10 can be manufactured.

A usage example of the gas flow sensor 10 will be described below. The control unit 40 adjusts the voltage applied between the discharge electrode 22 and each of the ground electrodes 24 and 24 such that the charges 18 are generated in a predetermined quantity per unit time. The generated charges 18 are moved along the gas flow and are captured by the charge capturing electrode 30. At that time, the charges 18 generated by the charge generator 20 reach the charge capturing electrode 30 in a shorter time at a larger gas flow rate. Therefore, a larger current flowing in the charge capturing electrode 30 implies that the gas flow rate is larger. FIG. 3 illustrates an example of a graph depicting a relation between the current flowing in the charge capturing electrode 30 and the gas flow rate. The control unit 40 stores the graph as a map or a numerical formula (calibration curve) in the ROM, determines a gas flow rate corresponding to the current input from the ammeter 38, and displays the determined gas flow rate on the display 42.

In the gas flow sensor 10 described above, the charges 18 generated with the aerial discharge caused by the charge generator 20 are captured by the charge capturing electrode 30, and the gas flow rate (information about the gas flow) is determined on the basis of the current that varies depending on a quantity of the captured charges. Such a method is based on a measurement principle unknown up to now. Thus, because of using the measurement principle unknown up to now, the gas flow sensor 10 is expected to be utilized in various fields by virtue of its advantage.

Furthermore, because of capturing the charges 18 under the electric field, the charge capturing electrode 30 can efficiently capture the charges 18.

Moreover, the discharge electrode 22 is disposed along the inner surface of the gas flow path 13, and the ground electrodes 24 and 24 are embedded in the wall (housing 12) of the gas flow path 13. Therefore, the gas flow passing through the gas flow path 13 is less susceptible to obstruction by the charge generator 20. As a result, the gas flow rate can be more accurately determined.

It is to be noted that the present invention is not limited to the above-described first embodiment and the present invention can be implemented in various embodiments insofar as falling within the technical scope of the present invention.

For example, while the first embodiment has been described, by way of example, in connection with the case in which the control unit 40 determines the gas flow rate on the basis of the current flowing in the charge capturing electrode 30, the control unit 40 may determine, instead of or in addition to the gas flow rate, the presence of pulsation of the gas, a frequency of the pulsation of the gas when generated, and/or the occurrence of clogging in the gas flow path 13. Upon the occurrence of the gas pulsation, the current flowing in the charge capturing electrode 30 is periodically interrupted. Accordingly, when the current flowing in the charge capturing electrode 30 is periodically interrupted, the control unit 40 can judge that the gas pulsation has occurred. Furthermore, the control unit 40 can determine a frequency of the pulsation from a period at that time. In addition, upon clogging in the gas flow path 13, a state in which the current flowing in the charge capturing electrode 30 is substantially zero continues. Accordingly, when the current flowing in the charge capturing electrode 30 is kept substantially zero for a predetermined time or longer, the control unit 40 can judge that the clogging in the gas flow path has occurred.

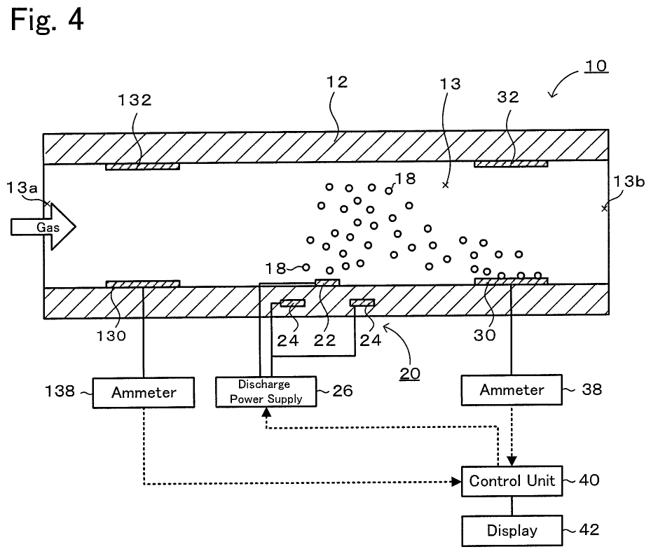

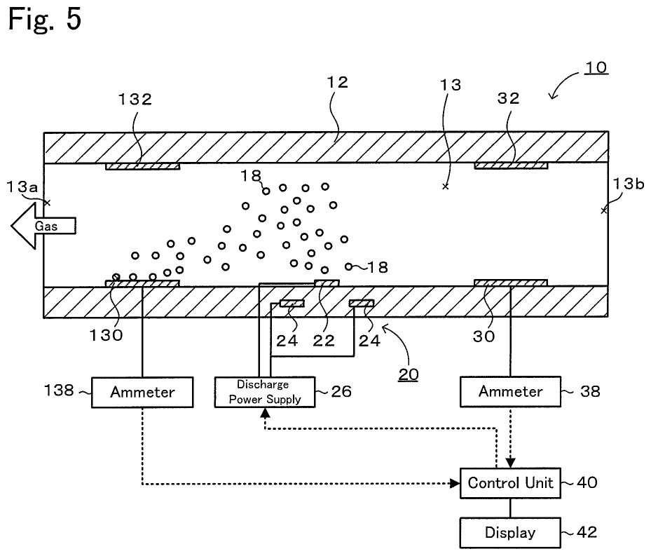

While, in the above first embodiment, the charge capturing electrode 30 is arranged between the charge generator 20 and the opening 13b of the gas flow path 13, a charge capturing electrode 130 may be further arranged, as illustrated in FIG. 4, between the charge generator 20 and the opening 13a of the gas flow path 13. An electric-field generation electrode 132 cooperating to capture the charges is disposed opposing to the charge capturing electrode 130. Thus, as with the charge capturing electrode 30, the charge capturing electrode 130 also captures the charges 18 under an electric field. An ammeter 138 is connected to the charge capturing electrode 130. A current detected by the ammeter 138 is output to the control unit 40. With that arrangement, the gas flow rate can be determined in not only the case in which the gas flows from the one opening 13a to the other opening 13b of the gas flow path 13 (see FIG. 4), but also the case in which the gas flows in a direction reversed to that in the above case (see FIG. 5). It is also possible to more accurately detect the occurrence of the gas pulsation and the frequency of the gas pulsation.

While, in the above first embodiment, the charge generator 20 is constituted by the discharge electrode 22 disposed along the inner surface of the gas flow path 13 and the two ground electrodes 24 and 24 embedded in the housing 12, the charge generator 20 may have any suitable structure insofar as it can generate the charges with the aerial discharge. For example, the ground electrodes 24 and 24 may be disposed along the inner surface of the gas flow path 13 instead of being embedded in the inner wall of the gas flow path 13. In such a case, the ground electrode 24 may be bonded to the inner surface of the gas flow path 13 with a glass paste interposed therebetween, or may be formed as a sintered metal by firing a metal paste that is coated on the inner surface of the gas flow path 13 by screen printing. Alternatively, the charge generator may be constituted by a needle electrode and a counter electrode as described in International Publication Pamphlet No. 2015/146456.

In the above first embodiment, a spacing (flow path thickness) between the charge capturing electrode 30 and the electric-field generation electrode 32 in the gas flow path 13 may be set to a minute value (e.g., not less than 0.01 mm and less than 0.2 mm). With that setting, the charges can be more easily captured by the charge capturing electrode 30 because the charges 18 generated by the charge generator 20 pass between the charge capturing electrode 30 and the electric-field generation electrode 32 while undergoing the Brown motion. In such a case, the charge capturing electrode 30 can capture the charges 18 even when the electric field is not generated (namely, when the voltage is not applied between the charge capturing electrode 30 and the electric-field generation electrode 32). In the case of not generating the electric field, the electric-field generation electrode 32 may be omitted. However, the electric field is preferably generated in order to more reliably capture the charges 18.

While, in the above first embodiment, the charge generator 20 is disposed on the lower side of the gas flow path 13, the charge generator 20 may be disposed on the upper side of the gas flow path 13 or on each of the upper and lower sides of the gas flow path 13.

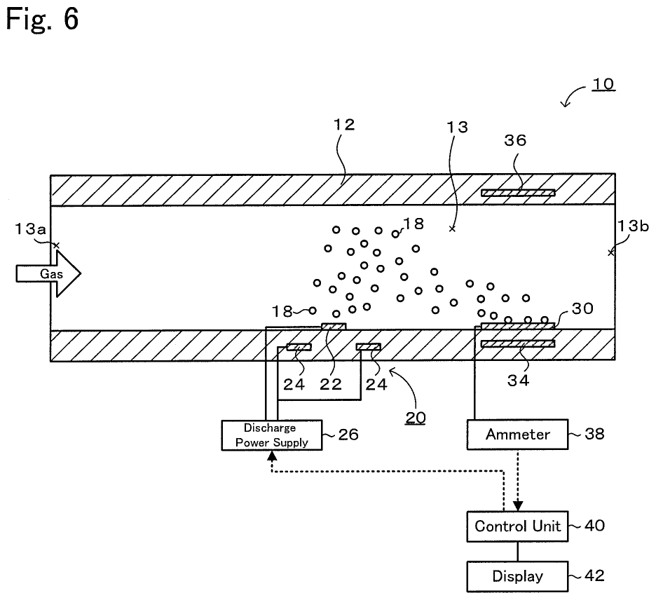

While, in the above first embodiment, the electric-field generation electrode 32 is disposed along the inner surface of the gas flow path 13, it may be embedded in the wall (housing 12) of the gas flow path 13. Instead of the electric-field generation electrode 32, as illustrated in FIG. 6, a pair of electric-field generation electrodes 34 and 36 may be embedded in the wall of the gas flow path 13 in a state sandwiching the charge capturing electrode 30. It is to be noted that, in FIG. 6, the same components as those in the above-described embodiment are denoted by the same reference signs. In such a case, the charges 18 are captured by the charge capturing electrode 30 by applying a voltage between the pair of the electric-field generation electrodes 34 and 36 to generate an electric field above the charge capturing electrode 30.

### Second Embodiment

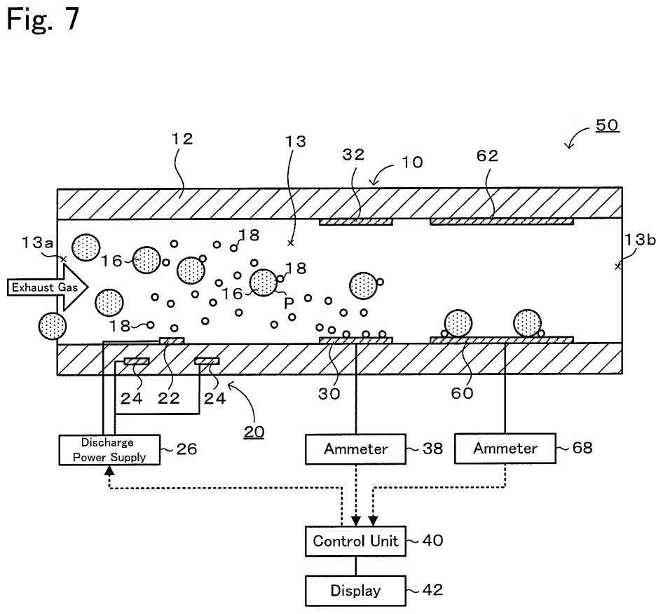

FIG. 7 is a sectional view illustrating a schematic structure of a particle counter 50.

The particle counter 50 is to count the number of particles 16 contained in exhaust gas of an internal combustion engine, etc., and it includes the gas flow sensor 10 and a charged particle capturing electrode 60 as illustrated in FIG. 7. In the gas flow path 13 formed within the housing 12, the charge generator 20, the charge capturing electrode 30, and the charged particle capturing electrode 60 are disposed side by side in the mentioned order from the upstream side toward the downstream side of the gas flow. The gas flow sensor 10 is as per described in the first embodiment, and description of the gas flow sensor 10 is omitted here. The components of the gas flow sensor 10 in FIG. 7 are denoted by the same reference signs as those in the first embodiment, and description of those components is omitted.

The charged particle capturing electrode 60 is disposed along the inner surface of the gas flow path 13. The particles 16 contained in the exhaust gas enter the gas flow path 13 from the opening 13a and turn to charged particles P because the charges 18 generated with the aerial discharge caused by the charge generator 20 are added to the particles 16 when the particles pass through the charge generator 20. The charged particle capturing electrode 60 captures the charged particles P. An electric-field generation electrode 62 cooperating to capture the charged particles is disposed in the gas flow path 13 at a position opposing to the charged particle capturing electrode 60. The electric-field generation electrode 62 is also disposed along the inner surface of the gas flow path 13. When a voltage of an electric-field generation power supply, not illustrated, is applied between the electric-field generation electrode 62 and the charged particle capturing electrode 60, an electric field is generated between the electric-field generation electrode 62 and the charged particle capturing electrode 60 (above the charged particle capturing electrode 60). The charged particles P are attracted to and captured by the charge capturing electrode 60 under the electric field. The sizes of the capturing electrodes 30 and 60 and the intensities of the electric field above the capturing electrodes 30 and 60 are set such that the charged particles P are captured by the charged particle capturing electrode 60 without being captured by the charge capturing electrode 30, and such that the charges 18 having not adhered to the particles 16 are captured by the charge capturing electrode 30. Thus, the charge capturing electrode 30 serves to remove the extra charges 18 having not been added to the particles 16.

An ammeter 68 is connected to the charged particle capturing electrode 60. The ammeter 68 detects a current flowing in the charged particle capturing electrode 60 and outputs the detected current to the control unit 40. The control unit 40 corresponds to first and second control units in the present invention.

An example of manufacturing the particle counter 50 will be described below. Of the particle counter 50, the housing 12 including the various electrodes 22, 24, 30, 32, 60 and 62 can be fabricated by using a plurality of ceramic green sheets. More specifically, after forming cutouts, through-heles, and/or grooves and screen-printing the electrodes and wiring patterns in and on the individual ceramic green sheets as required, those ceramic green sheets are laminated and fired. The cutouts, the through-heles, and the grooves may be previously filled with a material (e.g., an organic material) that disappears when fired. The housing 12 including the various electrodes 22, 24, 30, 32, 60 and 62 is thus obtained. Then, the discharge power supply 26 is connected to the discharge electrode 22 and the ground electrodes 24 and 24, the ammeter 38 is connected to the charge capturing electrode 30, and the ammeter 68 is connected to the charged particle capturing electrode 60. Furthermore, the control unit 40 is connected to the discharge power supply 26, the ammeters 38 and 68, and the display 42. In such a manner, the particle counter 50 can be manufactured.

A usage example of the particle counter 50 will be described below. The control unit 40 adjusts the voltage applied between the discharge electrode 22 and each ground electrode 24 such that the charges 18 are generated in a predetermined quantity per unit time. Ones among the generated charges 18, those ones having not adhered to the particles 16, are moved along a flow of the exhaust gas and are captured by the charge capturing electrode 30. As described in the first embodiment, the control unit 40 determines a flow rate of the exhaust gas on the basis of the current input from the ammeter 38 that is connected to the charge capturing electrode 30. Here, the number of the charges 18 generated by the charge generator 20 is much larger than that of the particles 16. Therefore, an error is small even when the flow rate of the exhaust gas is determined on the basis of the current from the ammeter 38. Furthermore, the control unit 40 determines the number of the particles contained in the exhaust gas per unit volume on the basis of both the detected current input from the ammeter 68 connected to the charged particle capturing electrode 60 and the flow rate of the exhaust gas, and displays the determined number on the display 42. The number of the particles (unit: number/cc) contained in the exhaust gas per unit volume is calculated from the following formula (1). In the formula (1), “detected current” (unit: A(=C/s)) denotes the current input from the ammeter 68. “Average charge number” (unit: number) denotes an average value of the charges 18 adhering to one particle 16, and it is a value that can be previously calculated from values measured by a microammeter and a particle number counter. “Elementary charge” (unit: C) denotes the constant also called an elementary charge quantity. “Flow rate” denotes the flow rate of the exhaust gas (unit: cc/s) detected by the gas flow sensor 10.

Number of particles=(detected current)/{(average charge number)×(elementary charge)×(flow rate)} (1)

Furthermore, when the current flowing in the charge capturing electrode 30 is periodically interrupted, the control unit 40 judges that pulsation of the exhaust gas has occurred, and stops the above-described operation of determining the number of the particles. The reason is that it is difficult to accurately determine the number of the particles when the pulsation of the exhaust gas has occurred. In such a case, the control unit 40 displays the occurrence of the pulsation on the display 42.

Moreover, when the state in which the current flowing in the charge capturing electrode 30 is zero continues for a predetermined time or longer, the control unit 40 judges that the clogging has occurred in the gas flow path 13, and stops the above-described operation of determining the number of the particles. The reason is that it is difficult to accurately determine the number of the particles when the clogging has occurred in the gas flow path 13. In such a case, the control unit 40 displays the occurrence of the clogging in the gas flow path 13 on the display 42.

According to the particle counter 50 described above, the number of the particles can be determined in consideration of the flow rate of the exhaust gas. In addition, since the flow rate of the exhaust gas and the number of the particles are both determined by utilizing the charges 18 generated with the aerial discharge caused by the charge generator 20, a device structure is made compact.

When the pulsation of the exhaust gas or the clogging has occurred, the operation of determining the number of the particles is stopped because of a difficulty in accurately determining the number of the particles. Thus, an operator is not bothered by the measurement result indicating the inaccurate number of the particles.

Since the particle counter 50 uses the gas flow sensor 10 according to the first embodiment, similar advantages to those of the first embodiment can also be obtained.

It is needless to say that the present invention is not limited to the above-described second embodiment and the present invention can be implemented in various embodiments insofar as falling within the technical scope of the present invention.

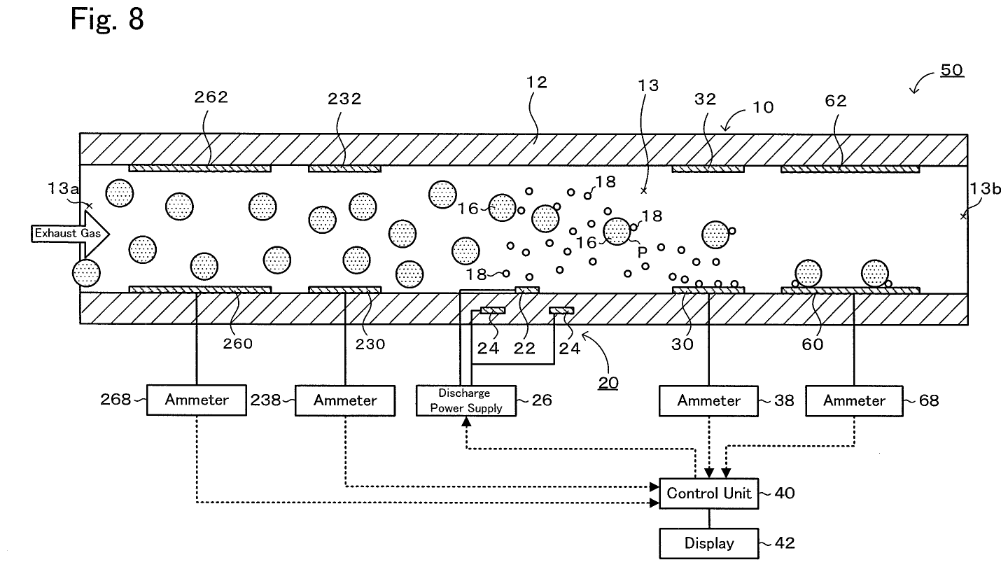

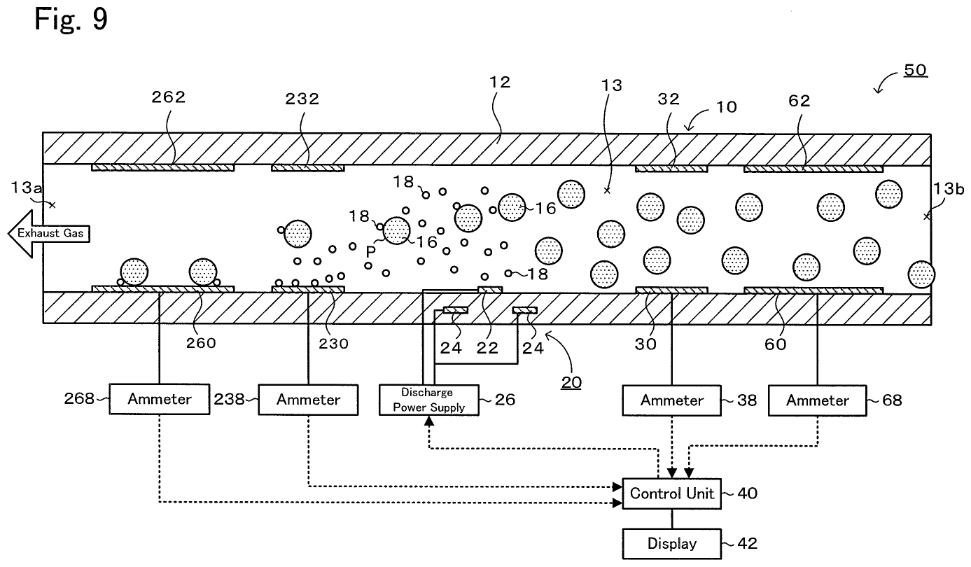

For example, in the above second embodiment, the charge generator 20, the charge capturing electrode 30, and the charged particle capturing electrode 60 are arranged side by side in the mentioned order along the direction from the one opening 13a toward the other opening 13b of the gas flow path 13. However, as illustrated in FIG. 8, a charged particle capturing electrode 260, a charge capturing electrode 230, the charge generator 20, the charge capturing electrode 30, and the charged particle capturing electrode 60 may be arranged side by side in the mentioned order along the direction from the one opening 13a toward the other opening 13b. An electric-field generation electrode 232 cooperating to capture the charges is disposed opposing to the charge capturing electrode 230, and an electric-field generation electrode 262 cooperating to capture the charged particles is disposed opposing to the charged particle capturing electrode 260. Thus, the charge capturing electrode 230 and the charged particle capturing electrode 260 also capture the charges 18 and the charged particles P, respectively, under electric fields. An ammeter 238 is connected to the charge capturing electrode 230, and an ammeter 268 is connected to the charged particle capturing electrode 260. Currents detected by the ammeters 238 and 268 are also output to the control unit 40. With that arrangement, the number of the particles 16 contained in the exhaust gas per unit volume can be determined in not only the case in which the exhaust gas flows from the one opening 13a to the other opening 13b of the gas flow path 13 (see FIG. 8), but also the case in which the exhaust gas flows in a direction reversed to that in the above case (see FIG. 9).

Instead of the charge generator 20 in the above second embodiment, a charge generator having a different structure such as described in the first embodiment may be used (for example, a charge generator including a needle electrode and a counter electrode).

In the above second embodiment, a spacing (flow path thickness) between the charged particle capturing electrode 60 and the electric-field generation electrode 62 in the gas flow path 13 may be set to a minute value (e.g., not less than 0.01 mm and less than 0.2 mm). With that setting, the charged particles P can be more easily captured by the charged particle capturing electrode 60 because the charged particles P pass between the charged particle capturing electrode 60 and the electric-field generation electrode 62 while undergoing the Brown motion.

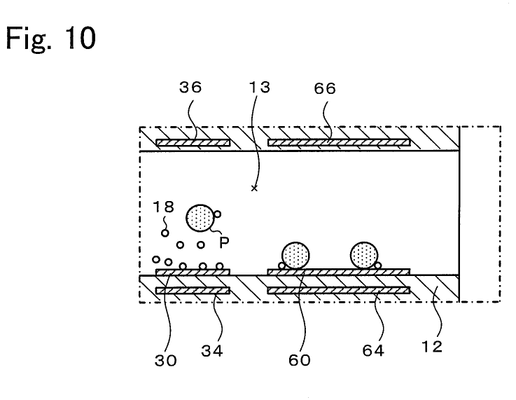

In the above second embodiment, the pair of electric-field generation electrodes 34 and 36 illustrated in FIG. 6 may be used instead of the electric-field generation electrode 32, and an electric field may be generated above the charge capturing electrode 30 by applying a voltage between both the electrodes 34 and 36. Furthermore, as illustrated in FIG. 10, the pair of electric-field generation electrodes 34 and 36 may be embedded instead of the electric-field generation electrode 32 in the wall of the gas flow path 13 in a state sandwiching the charge capturing electrode 30, and a pair of electric-field generation electrodes 64 and 66 may be embedded instead of the electric-field generation electrode 62 in the wall of the gas flow path 13 in a state sandwiching the charged particle capturing electrode 60. In such a case, the charges 18 are captured by the charge capturing electrode 30 by applying a voltage between the pair of the electric-field generation electrodes 34 and 36 to generate an electric field above the charge capturing electrode 30. Moreover, the charged particles P are captured by the charged particle capturing electrode 60 by applying a voltage between the pair of the electric-field generation electrodes 64 and 66 to generate an electric field above the charged particle capturing electrode 60.

The above second embodiment may include a heater for heating and incinerating the particles deposited on the charged particle capturing electrode 60. This enables the charged particle capturing electrode 60 to be refreshed with supply of power to the heater.

### Third Embodiment

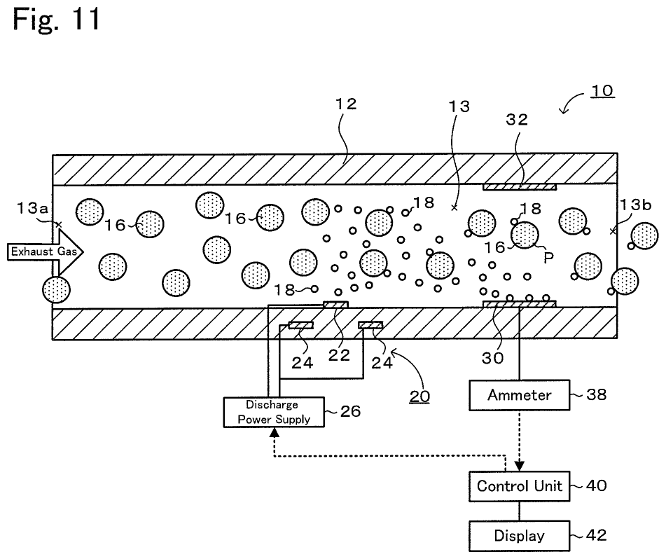

FIG. 11 is a sectional view illustrating a schematic structure when the gas flow sensor 10 according to the first embodiment is directly used as a particle counter. A usage example in the case of using the gas flow sensor 10 as the particle counter will be described below. The exhaust gas containing the particles 16 is introduced to flow from the one opening 13a toward the other opening 13b of the gas flow path 13. The control unit 40 adjusts the voltage applied between the discharge electrode 22 and each ground electrode 24 such that the charges 18 are generated in a predetermined quantity per unit time. The size of the charge capturing electrode 30 and the intensity of the electric field above the charge capturing electrode 30 are set such that extra charges (i.e., ones among the charges 18 generated by the charge generator, those ones having not adhered to the particles 16) are captured by the charge capturing electrode 30, but the charged particles P are not captured by the charge capturing electrode 30. As described in the first embodiment, the control unit 40 determines a flow rate of the exhaust gas on the basis of the current input from the ammeter 38 that is connected to the charge capturing electrode 30. Furthermore, the control unit 40 determines the number of the particles contained in the exhaust gas per unit volume on the basis of both the detected current input from the ammeter 68 connected to the charge capturing electrode 30 and the flow rate of the exhaust gas, and displays the determined number on the display 42. The number of the particles (unit: number/cc) contained in the exhaust gas per unit volume is obtained through steps of determining the number of the extra charges (=current/elementary charge) per unit time on the basis of the current flowing in the charge capturing electrode 30, dividing the difference resulted from subtracting the number of the extra charges from a total number of the charges 18, which have been generated by the charge generator 20 per unit time, by an average charge number of the charged particles P, thus calculating the number of the charged particles, and dividing the calculated number of the charged particles by the flow rate. The control unit 40 corresponds to the first and second control units in the present invention.

Furthermore, when the current flowing in the charge capturing electrode 30 is periodically interrupted, the control unit 40 judges that pulsation of the exhaust gas has occurred, and stops the above-described operation of determining the number of the particles. The reason is that it is difficult to accurately determine the number of the particles when the pulsation of the exhaust gas has occurred. In such a case, the control unit 40 displays the occurrence of the pulsation on the display 42.

Moreover, when the state in which the current flowing in the charge capturing electrode 30 is zero continues for a predetermined time or longer, the control unit 40 judges that the clogging has occurred in the gas flow path 13, and stops the above-described operation of determining the number of the particles. The reason is that it is difficult to accurately determine the number of the particles when the clogging has occurred in the gas flow path 13. In such a case, the control unit 40 displays the occurrence of the clogging in the gas flow path 13 on the display 42.

According to the above-described particle counter using the gas flow sensor 10 as it is, the number of the particles can be determined in consideration of the flow rate of the exhaust gas. In addition, since the flow rate of the exhaust gas and the number of the particles are both determined by utilizing the charges 18 generated with the aerial discharge caused by the charge generator 20, a device structure is made compact.

When the pulsation of the exhaust gas or the clogging has occurred, the operation of determining the number of the particles is stopped because of a difficulty in accurately determining the number of the particles. Thus, the operator is not bothered by the measurement result indicating the inaccurate number of the particles.

Since the gas flow sensor 10 according to the first embodiment is used as the particle counter, similar advantages to those of the first embodiment can also be obtained.

It is needless to say that the present invention is not limited to the above-described third embodiment and the present invention can be implemented in various embodiments insofar as falling within the technical scope of the present invention.

For example, while the third embodiment has been described above in connection with the case of using the gas flow sensor 10 according to the first embodiment as the particle counter, the gas flow sensor 10 illustrated in FIG. 4 may be used as the particle counter. This enables the number of the particles to be determined in consideration of the flow rate of the exhaust gas in not only the case in which the exhaust gas containing the particles 16 flows from the one opening 13a to the other opening 13b of the gas flow path 13, but also the case in which the exhaust gas flows in a direction reversed to that in the above case.

Instead of the charge generator 20 in the above-described third embodiment, a charge generator having a different structure such as described in the first embodiment may be used.

In the above-described third embodiment, the pair of electric-field generation electrodes 34 and 36 illustrated in FIG. 6 may be used instead of the electric-field generation electrode 32, and an electric field may be generated above the charge capturing electrode 30 by applying a voltage between both the electrodes 34 and 36.

While, in the above-described third embodiment, the control unit 40 is used as the first and second control units in the present invention, the present invention is not limited to such a particular case. For example, the control unit 40 may be used as the first control unit, and a control unit different from the control unit 40 may be used as the second control unit. The above point is similarly applied to the second embodiment.

The present application claims priority from Japanese Patent Application No. 2017-155299 filed on Aug. 10, 2017, the entire contents of which are incorporated herein by reference.

What is claimed is:

1. A gas flow sensor comprising:
a housing including a gas flow path;
a charge generator causing aerial discharge and generating charges within the gas flow path;
a charge capturing electrode capturing the charges generated within the gas flow path; and
a first control unit determining information about a gas flow on the basis of a physical quantity that varies depending on a quantity of the charges captured by the charge capturing electrode.

2. The gas flow sensor according to claim 1, wherein the information is at least one among a flow rate of gas flowing through the gas flow path, a flow speed of the gas, a frequency of pulsation of the gas when generated, presence of the pulsation of the gas, and occurrence of clogging in the gas flow path.

3. The gas flow sensor according to claim 1, wherein the charge capturing electrode captures the charges under an electric field.

4. The gas flow sensor according to claim 1, wherein the charge generator includes a discharge electrode and a ground electrode,
the discharge electrode is disposed along an inner surface of the gas flow path, and
the ground electrode is embedded in the housing or disposed along the inner surface of the gas flow path.

5. The gas flow sensor according to claim 1, wherein the charge capturing electrode is disposed at each of positions between the charge generator and one opening of the gas flow path and between the charge generator and the other opening of the gas flow path.

6. A particle counter counting number of particles contained in gas, the particle counter comprising:
the gas flow sensor according to claim 1;
a charged particle capturing electrode capturing charged particles that are produced with addition of the charges to the particles contained in the gas flowing into the gas flow path; and
a second control unit determining number of the particles on the basis of a physical quantity that varies depending on a quantity of the charges captured by the charged particle capturing electrode,
wherein the charge generator, the charge capturing electrode, and the charged particle capturing electrode are disposed side by side in the mentioned order,
the first control unit determines at least a flow rate of the gas, and
the second control unit determines number of the particles in the gas per unit volume on the basis of both the physical quantity that varies depending on the quantity of the charges captured by the charged particle capturing electrode and the flow rate of the gas determined by the first control unit.

7. A particle counter counting number of particles contained in gas, the particle counter comprising:
the gas flow sensor according to claim 1; and
a second control unit determining number of the particles on the basis of a physical quantity that varies depending on a quantity of the charges captured by the charge capturing electrode,
wherein the first control unit determines at least a flow rate of the gas,
the charge capturing electrode does not capture charged particles that are produced with addition of the charges to the particles contained in the gas flowing into the gas flow path, and captures extra charges having not been added to the particles, and
the second control unit determines number of the particles in the gas per unit volume on the basis of both the physical quantity that varies depending on the quantity of the charges captured by the charge capturing electrode and the flow rate of the gas determined by the first control unit.

8. The particle counter according to claim 6, wherein the first control unit detects presence of pulsation of the gas, and
the second control unit stops an operation of determining the number of the particles when the pulsation of the gas is detected by the first control unit.

9. The particle counter according to claim 7, wherein the first control unit detects presence of pulsation of the gas, and
the second control unit stops an operation of determining the number of the particles when the pulsation of the gas is detected by the first control unit.

10. The particle counter according to claim 6, wherein the first control unit detects occurrence of clogging in the gas flow path, and
the second control unit stops an operation of determining the number of the particles when the clogging in the gas flow path is detected by the first control unit.

11. The particle counter according to claim 7, wherein the first control unit detects occurrence of clogging in the gas flow path, and
the second control unit stops an operation of determining the number of the particles when the clogging in the gas flow path is detected by the first control unit.
